(19) United States
(12) Patent Application Publication
(10) Pub. No.: US 2026/0093539 A1
(43) Pub. Date: Apr. 2, 2026

(54) SYSTEMS AND METHODS FOR ARTIFICIAL INTELLIGENCE BASED PIPELINE-AWARE ORCHESTRATION

(71) Applicant: SK Hynix NAND Product Solutions Corp. (dba Solidigm), Rancho Cordova, CA (US)

(72) Inventors: Rita H. WOUHAYBI, Portland, OR (US); Caleb MCMILLAN, Forest Grove, OR (US)

(21) Appl. No.: 18/903,917

(22) Filed: Oct. 1, 2024

(51) Int. Cl. G06F 9/50

(52) U.S. Cl. CPC G06F 9/5027

(57) ABSTRACT

Some embodiments are directed to systems and methods that dynamically allocate resources to process data according to delay tolerances. In one aspect, a computer system includes one or more processors and memory. The computer system establishes a plurality of data paths based on the one or more processors and the memory. The plurality of data paths are substantially parallel and include a first data path. The computer system obtains input data and processes the input data in the plurality of data paths to generate a plurality of output data. The computer system, for at least the first data path, determines a first delay state of the first data path and based on the first delay state, dynamically allocates a first subset of the one or more processors for processing the input data in the first data path.

### TECHNICAL FIELD

The present application generally relates to computer technology, and more particularly to, methods, systems, and non-transitory computer readable storage media for dynamically allocating resources for processing data according to a delay tolerance of the data path.

### BACKGROUND

Edge computing brings enterprise applications closer to data sources. The proximity to data at its source can lead to faster insights, shorter response times, and better bandwidth availability.

### SUMMARY

AI applications can be described as a pipeline of multiple functions. For example, a system for defect detection can be represented as a pipeline, where different parts of the pipeline are suited for different kinds of data computations. For example, a resize can run efficiently on a co-processor whereas deep learning functions such as object detection are best executed on a general purpose graphics processing unit (GPGPU). A system like this, when deployed at scale at the edge, can span hundreds of nodes with many instances operating on multiple parts of a physical environment. For example, in a factory, several copies of the pipeline (e.g., each pipeline corresponding to data acquired from a respective camera) are needed and deployed and managed.

Current manageability frameworks are configured to manage pipelines of multiple functions by deploying containers. However, these frameworks are not designed to understand that certain parts of a pipeline may be time-sensitive (e.g., requiring an answer under 100 msec) whereas other parts of the pipeline may be delay-tolerant (e.g., can tolerate delays in the order of minutes or hours). For example, in a factory line, a time-sensitive situation can be the detection of the defect whereas a delay-tolerant situation is the application of a predictive maintenance model to predict a robotic failure to occur during the following day.

Accordingly, what is needed are manageability frameworks that are configured to understand and accommodate different latency requirements in different parts of a pipeline, and dynamically allocate (or re-allocate) computational resources accordingly.

Some embodiments of the present disclosure are directed to methods, systems, and non-transitory computer readable storage media for dynamic allocation of processing resources for processing data.

In one aspect, a method for processing data is implemented at a computer system having one or more processors and memory. The method includes establishing a plurality of data paths based on the one or more processors and the memory. The plurality of data paths are substantially parallel and include a first data path. The method includes obtaining input data. The method includes processing the input data in the plurality of data paths to generate a plurality of output data. The method includes, for at least the first data path: determining a first delay state of the first data path; and based on the first delay state, dynamically allocating a first subset of the one or more processors for processing the input data in the first data path.

In some embodiments, the plurality of output data includes first output data that are generated by the first data path and used to generate a first instruction. The method further includes, in response to the first instruction, controlling a machine to implement an operation on a target operation automatically and without human intervention.

In some embodiments, the method includes, for at least the first data path, dynamically allocating a first cache memory space for processing the input data in the first data path.

In some embodiments, dynamically allocating the first subset of the one or more processors for processing the input data in the first data path includes varying at least one of a size and a type of the first subset of the one or more processors.

In some embodiments, determining the first delay state of the first data path includes determining a first delay time of the first data path; and determining whether the first delay time satisfies a first delay requirement. The first delay state indicates whether the first delay requirement is satisfied.

According to another aspect of the present application, a computer system includes one or more processors and memory. The memory stores instructions that, when executed by the one or more processors, cause the computer system to perform any of the methods for processing data as disclosed herein.

According to another aspect of the present application, a non-transitory computer readable storage medium stores instructions configured for execution by a computer system that includes one or more processors and memory. The instructions, when executed by the one or more processors, cause the computer system to perform any of the methods for processing data as disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The accompanying drawings, which are included to provide a further understanding of the embodiments, are incorporated herein, constitute a part of the specification, illustrate the described embodiments, and, together with the description, serve to explain the underlying principles.

FIG. 1 depicts a representative smart work environment, in accordance with some implementations.

FIG. 2 is an example operating environment in which a smart device interacts with a client device or a server system, in accordance with some implementations.

FIG. 3 is a block diagram illustrating a computer system of a smart work environment, in accordance with some implementations.

FIG. 4 is a block diagram of a machine learning system for training and applying data processing models using machine learning, in accordance with some embodiments.

FIG. 5A is a structural diagram of an example neural network applied to process work data in a data processing model, in accordance with some embodiments.

FIG. 5B is an example node in the neural network, in accordance with some embodiments.

FIG. 6 illustrates an exemplary workflow associated with a warehousing application, in accordance with some embodiments.

FIGS. 7A and 7B illustrate exemplary data path scenarios, in accordance with some embodiments.

FIGS. 8A to 8D provide a flowchart of an example process for processing data, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

Various embodiments of this application are directed to AI applications that are deployed at scale on the edge. In accordance with some embodiments of the present disclosure, at a computer system includes one or more processors and memory. In some embodiments, the one or more processors comprise a plurality of processors corresponding to a plurality of processor types. In some embodiments, the processor types include one or more of: a central processing unit (CPU), and graphics processing unit (GPU), an integrated graphics processing (iGPU), a general purpose graphics processing unit (iGPU), and a tensor processing unit (TPU). The computer system establishes a plurality of data paths, for processing data, based on the one or more processors and the memory. In some embodiments, a respective data path is also referred to as a processing pipeline or an AI pipeline. In some embodiments, the plurality of data paths are substantially parallel (e.g., at least partially parallel) and include a first data path. The computer system obtains input data, and processes the input data in the plurality of data paths to generate a plurality of output data. In some embodiments, the computer system applies one or more data processing models successively in the first data path to process the input data. In some embodiments, each of the data paths uses the same input data. In some embodiments, at least two of the data paths use different input data. the computer system, for at least the first data path, determines a first delay state of the first data path. In some embodiments, the first data path generates a first output that is used (e.g., by the CPU) to perform business logic operations (e.g., rule-based operations, such as publishing, storing, or visualizing operations). In some embodiments, the first delay state includes a state where a business logic operation ready to be executed but is waiting for an output of the first processing pipeline before it can be executed. In some embodiments, the first delay state includes a state where a first output of the first processing pipeline has been generated, but the business logic operation is not performed until a subsequent time (e.g., 2 hours later or one day later). In some embodiments, the computer system, based on the first delay state, dynamically allocates a first subset of the one or more processors for processing the input data in the first data path. In some embodiments, dynamically allocating a first subset of the one or more processors includes varying at least one of a size (e.g., a number of processing cores, e.g., from two to three cores out of a total number of cores or from three to two cores out of a total number of processing cores, or a cache size) and a type (e.g., CPU or GPU or TPU) of the first subset of the one or more processors.

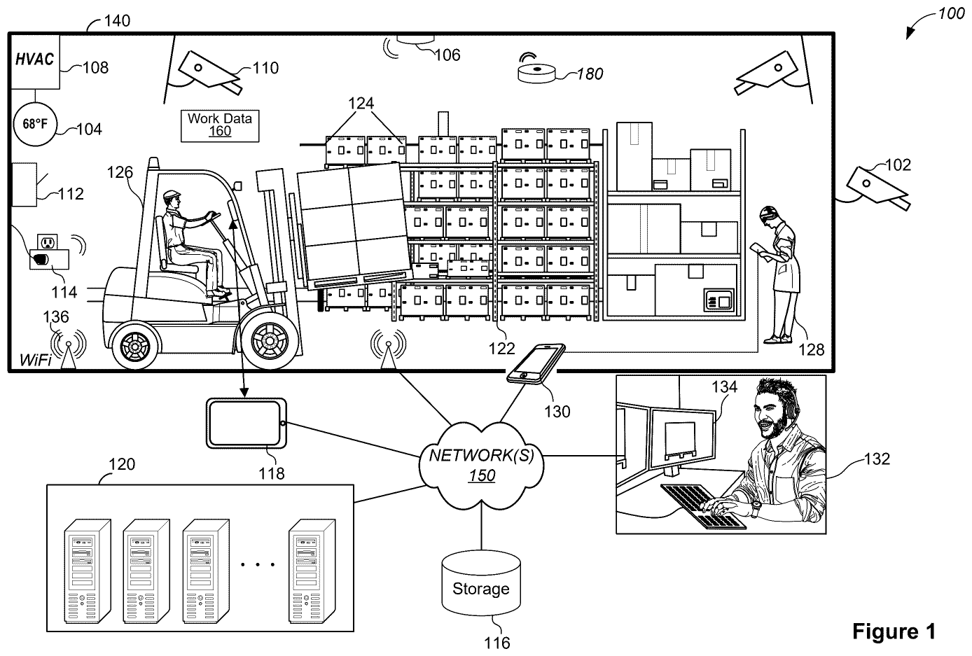

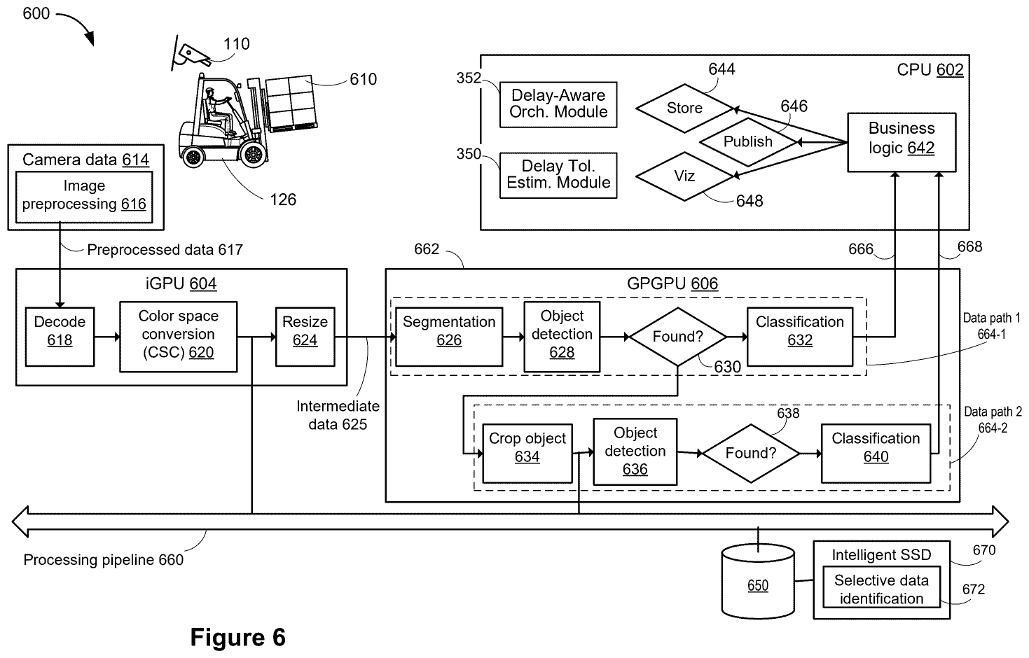

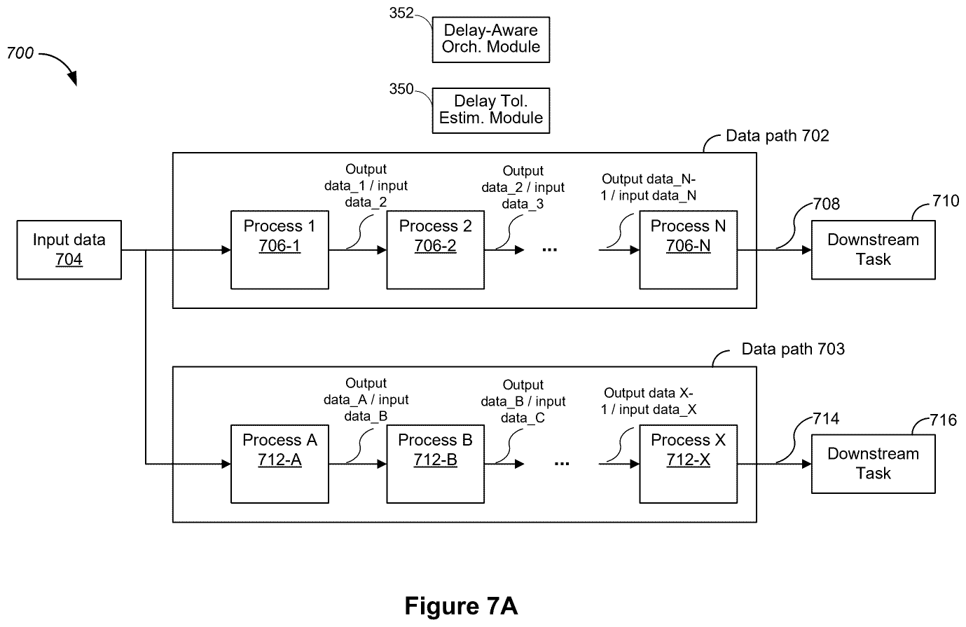

FIG. 1-5B provide background exemplary sensor device networks and capabilities (e.g., machine learning based data processing capabilities) described herein, which are helpful in understanding the details of the embodiments described from FIG. 6 onward.

FIG. 1 depicts a representative smart work environment 100 in accordance with some implementations. The smart work environment 100 includes a structure 140, which may be used as a warehouse, factory, construction site, farm, laboratory, office space, retail store, hospital, and the like. For example, the structure 140 may be used as a distribution center, an e-commerce fulfillment center, an automobile assembly plant, an electronics manufacturing facility, a supermarket, or a retailer store. It will be appreciated that the structure 140 has an open floor plan, high ceilings, and support structures (e.g. columns or beams) and may include different functional areas designed for efficiency, safety, and scalability. Further, the smart work environment 100 may control and/or be coupled to devices outside of the actual structure 140. Indeed, several devices in the smart work environment 100 need not be physically within the structure 140. For example, a surveillance camera 102 may be located outside of the structure 140.

The depicted structure 140 may include a plurality of areas (e.g., storage areas, work areas) that may not be physically separated by walls. The depicted structure 140 may also include rooms (not shown) that are separated from the plurality of areas by walls. Devices may be mounted on, integrated with, and/or supported by a wall, a floor, a ceiling, or a support structure of the structure 140. Alternatively, devices may be mounted on, integrated with, and/or supported by an object (e.g., a shelf 122, a forklift 126) fixed or moveable in the structure 140.

In some implementations, the smart work environment 100 includes a plurality of devices, including intelligent, multi-sensing, network-connected devices, that integrate seamlessly with each other in a network 150 and/or with a central server system 120 or a cloud-computing system to provide a variety of useful smart work functions. The smart work environment 100 may include one or more surveillance cameras 102, one or more intelligent, multi-sensing, network-connected thermostats 104 (“smart thermostats”) and one or more intelligent, network-connected, multi-sensing hazard detection units 106 (“smart hazard detectors”). In some implementations, the smart thermostat 104 detects ambient climate characteristics (e.g., temperature and/or humidity) and controls an HVAC system 108 accordingly. The smart hazard detector 106 may detect the presence of a hazardous substance or a substance indicative of a hazardous substance (e.g., smoke, fire, and/or carbon monoxide). The surveillance cameras 102 may detect a person's or a vehicle's approach to or departure from the structure 140, identify and/or report any abnormal incidents, and/or control settings on a security system (e.g., to activate or deactivate the security system).

In some implementations, the smart work environment 100 includes one or more intelligent, multi-sensing, network-connected wall switches 112 (“smart wall switches”), along with one or more intelligent, multi-sensing, network-connected wall plug interfaces 114 (“smart wall plugs”). The smart wall switches 112 may detect ambient lighting conditions, detect room-occupancy states, and control a power and/or dim state of one or more lights. In some instances, smart wall switches 112 may also control a power state or speed of a fan, such as a ceiling fan. The smart wall plugs 114 may detect occupancy of a room or enclosure and control supply of power to one or more wall plugs (e.g., such that power is not supplied to the plug if nobody is present in the structure 140).

In some implementations, the smart work environment 100 includes a plurality of network-connected cameras 110 that are configured to provide video monitoring and security inside the structure 140. For example, the structure 140 is used as a warehouse, which is a bustling hub of activity, with neatly organized shelves 122 stretching high to accommodate an extensive inventory of product boxes 124. Each shelf 122 is carefully labeled and arranged to maximize space and ensure efficient access to goods. A forklift 126 may navigate the wide aisles with precision, lifting and moving boxes 124 from one location to another with a steady hum of its engine. The forklift 126 may include a computer device 118 for obtaining and updating information of the boxes 124 (e.g., box locations, weights, handling details). A worker 128 may check the stock levels on a handheld device 130, verifying the quantities and ensuring that inventory records match the physical stock. The air is filled with the sounds of the forklift's beeping and the occasional rustle of boxes as the warehouse maintains a routine of receiving, storing, and preparing products for distribution. A plurality of cameras 110 are distributed at different locations in the structure 140, and configured to capture static images or video clips monitoring activities of the forklift 126 and the worker 128.

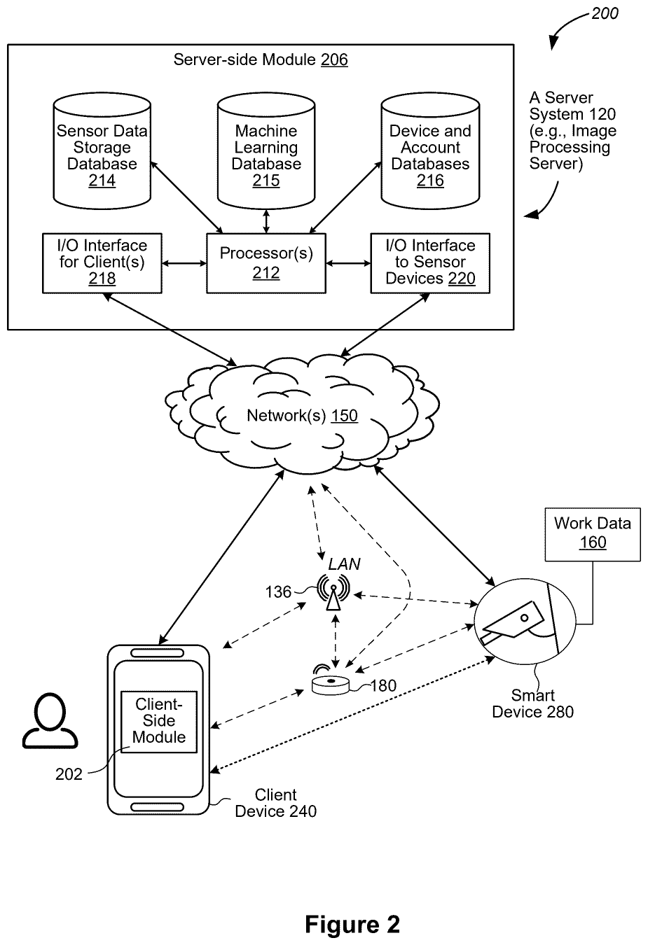

The devices 102-114 (e.g., collectively called smart devices 280 in FIG. 2) are examples of sensors and actuators that are disposed in the smart work environment 100 for collecting work data 160 (e.g., image data captured by cameras 110, temperature data captured by the smart thermostat 104). In some embodiments now shown, a variety of smart devices 280 are used to optimize efficiency and ensure smooth operations in the smart work environment 100. For example, radio frequency identification (RFID) sensors are employed to track products throughout the structure 140, ensuring that items are accurately located and inventoried. Proximity sensors may help robots and autonomous vehicles navigate safely by detecting obstacles and other machines. Infrared and optical sensors are used for barcode scanning, enabling quick identification of products. Additionally, pressure and weight sensors ensure that items are handled carefully and that shipping weights are accurate. Additional environmental sensors monitor conditions such as humidity to protect sensitive products. These technologies work together to create a highly automated and efficient smart work environment 100.

By virtue of network connectivity, one or more of the smart devices 280 may further allow a user to interact with the devices even if a user 132 is not proximate to the devices For example, the user 132 may communicate with a device using a computer device 134 (e.g., a desktop computer, laptop computer, a tablet computer, or other portable electronic device (e.g., a smartphone)). A webpage or application may be configured to receive communications from the user 132 and control the smart devices 280 based on the communications and/or to present information about the device's operation to the user 132. For example, the user 132 may view a current set point temperature for the smart thermostat 104 and adjust it using the computer device 134. The user 132 may review signature events captured by the camera 110 or adjust settings of the camera 110 using the computer device 134. The user 132 may be physically located within or outside the structure 140 during this remote communication.

As discussed above, users may control the smart thermostat 104 and other smart devices in the smart work environment 100 using a network-connected computer device 134. In some examples, a plurality of employees of a business entity associated with the structure 140 may register their devices 134 with the smart work environment 100. Such registration may be made at a central server 120 to authenticate the employees and/or the devices 134 as being associated with the structure 140 and to give permission to the employees to use the devices 134 to access the smart devices 280 in the structure 140. Employees may use their registered devices 134 to remotely control the smart devices 280 of the structure 140, e.g., when an employee is at work, on vacation, or at a separate office location. The employee may also use a registered device 134 (e.g., handheld device 130) to control the smart devices 280 when the employee is actually located inside the structure 140, such as when the employee is checking stocking in the warehouse.

In some implementations, in addition to containing processing and sensing capabilities, the devices 102, 104, 106, 108, 110, 112, and/or 114 (“the smart devices”) are capable of data communications and information sharing with other smart devices, a central server or cloud-computing system, and/or other devices that are network-connected. The required data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any of a variety of custom or standard wired protocols (e.g., CAT6 Ethernet or HomePlug), or any other suitable communication protocol.

In some implementations, the smart devices 280 serve as wireless or wired repeaters. For example, a first one of the smart devices communicates with a second one of the smart devices via a wireless router. The smart devices may further communicate with each other via a connection to one or more networks 150 such as the Internet. Through the one or more networks 150, the smart devices may communicate with a smart work server system 120 (also called a central server system and/or a cloud-computing system herein). In some implementations, the smart work server system 120 may include multiple server systems, each dedicated to data processing associated with a respective subset of the smart devices (e.g., a video server system may be dedicated to data processing associated with camera(s) 110). The smart work server system 120 may be associated with a manufacturer, support entity, or service provider associated with the smart devices 280. In some implementations, the smart work environment 100 relies on a dedicated hub device 180 to manage smart devices 280 located within the smart work environment 100, and a hub device server system associated with the hub device 180 serves as the server system 120.

In some implementations, a user is able to contact customer support using a smart device itself rather than needing to use other communication means, such as a telephone or Internet-connected computer. In some implementations, software updates are automatically sent from the smart work server system 120 to smart devices 280 (e.g., when available, when purchased, or at routine intervals). In some embodiments, the smart work environment 100 further includes a storage 116 for storing data related to the servers 120, smart devices 280, client devices 118, 130, and 134 (e.g., collectively called client device 240 in FIG. 2), and applications executed on the client devices. In some embodiments, the storage 116 includes a plurality of SSDs.

FIG. 2 is an example operating environment 100 in which a smart device 280 (e.g., cameras 110) interacts with a client device 240 (e.g., devices 118, 130, and 134 in FIG. 1) or a server system 120 (e.g., an image processing server), in accordance with some implementations. In the operating environment 200, the server system 120 provides data processing for monitoring and facilitating review of object location/motion associated with imaging device data streams (e.g., raw or processed work data 160) captured by multiple cameras 110 disposed in the structure 140. As shown in FIG. 2, the server system 120 may receive raw or processed work data 160 from smart devices 280 (standalone or integrated) located at various physical locations in the smart work environments 100. Each smart device 280 may be bound to one or more reviewer accounts, and the server system 120 may further process the received work data 160 to obtain information associated with the smart device 280 and the corresponding reviewer accounts. For a camera 110, the obtained information could be object locations, object movements, user gestures, and depth mapping. In some implementations, the server system 120 provides the information to client devices 240 associated with the reviewer accounts. In some implementations, the server system 120 uses the information to control a smart device 280 linked to the reviewer accounts.

In some implementations, the server system 120 is a dedicated image processing server that provides data processing services to cameras 110 and client devices 240 independently of other services provided by the server system 120.

In some implementations, each of the smart devices 280 captures work data 160 using signal detectors and sends the captured work data 160 to the server system 120 substantially in real time. In some implementations, each of the smart devices 280 includes a controller device (e.g., a smart device in which a camera 110 is integrated) that serves as an intermediary between the smart device 280 and the server system 120. The controller device receives the work data 160 from the one or more smart devices 280, optionally performs some preliminary processing on the work data 160, and sends the processed work data 160 to the server system 120 on behalf of the one or more smart devices 280 substantially in real time. In some implementations, each smart device 280 has its own on-board processing capabilities to perform some preliminary processing on the captured work data 160 before sending the processed work data 160 (along with metadata obtained through the preliminary processing) to the controller device and/or the server system 120. In some implementations, the client device 240 located in the smart work environment 100 functions as the controller device to at least partially process the captured work data 160.

In accordance with some implementations, each of the client devices 240 includes a client-side module 202. The client-side module 202 communicates with a server-side module 206 executed on the server system 120 through the one or more networks 150. The client-side module 202 provides client-side functionality for information monitoring, review processing, and communication with the server-side module 206. The server-side module 206 provides server-side functionality for event monitoring and review processing for any number of client-side modules 202, each residing on a respective client device 240. The server-side module 206 also provides server-side functionality for response processing and device control for any number of the smart devices 280.

In some implementations, the server-side module 206 includes one or more processors 212, a sensor data database 214, machine learning database 215, device and account databases 216, an I/O interface 218 to one or more client devices, and an I/O interface 220 to one or more smart devices 280. The I/O interface 218 to one or more clients facilitates the client-facing input and output processing for the server-side module 206. The device and account databases 216 store a plurality of profiles for reviewer accounts registered with the server system 120. A user profile includes account credentials for each reviewer account, and identifies one or more smart devices 280 linked to the reviewer account. In some implementations, the user profile of each reviewer account includes information related to capabilities, device characteristics, and lookup tables for the smart devices 280 linked to the reviewer account. The I/O interface 220 to one or more imaging devices facilitates communications with one or more smart devices 280 (standalone or integrated). The sensor data storage database 214 stores raw or processed work data 160 received from the smart devices 280 and associated information, as well as various types of metadata, such as device characteristics of signal emitters and detectors, lookup tables, modulation signals, and sampling rates. In some implementations, this data is used for generating additional information associated with each reviewer account. The machine learning database 215 stores data used by the server 120, the smart devices 280, or the client devices 240 to process the work data 160 collected by the smart devices 280 based on machine learning. For example, machine learning based data processing models and associated training data are stored in the machine learning database 215.

Client devices 240 include handheld computers, wearable computing devices, personal digital assistants (PDAs), tablet computers, laptop computers, desktop computers, cellular telephones, smart phones, enhanced general packet radio service (EGPRS) mobile phones, media players, navigation devices, game consoles, televisions, remote controls, point-of-sale (POS) terminals, vehicle-mounted computers, ebook readers, or a combination of any two or more of these data processing devices or other data processing devices.

Examples of the one or more networks 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 120 is implemented on one or more standalone data processing devices or a distributed network of computers. In some implementations, the server system 120 employs various virtual devices and/or services of third party service providers (e.g., third-party cloud service providers) to provide the underlying computing resources and/or infrastructure resources of the server system 120. In some implementations, the server system 120 includes handheld computers, tablet computers, laptop computers, desktop computers, or a combination of any two or more of these data processing devices or other data processing devices.

The server-client environment 200 shown in FIG. 2 includes both a client-side portion (e.g., the client-side module 202) and a server-side portion (e.g., the server-side module 206). The division of functionality between the client and server portions of operating environment 200 can vary in different implementations. Similarly, the division of functionality between the smart devices 280 and the server system 120 can vary in different implementations. In some implementations, the client-side module 202 is a thin-client that provides only user-facing input and output processing functions, and delegates other data processing functionality to a backend server (e.g., the server system 120). In some implementations, a smart device 280 is a simple data capturing device that continuously captures and streams work data 160 to the server system 120, with limited local preliminary processing of the data. Although many aspects of the present technology are described from the perspective of a computer system (e.g., system 300) as a whole, the corresponding actions performed by the client device 240 and/or the server system 120 would be apparent to those of skill in the art. Some aspects of the present technology may be described from the perspective of the client device or the server system, and the corresponding actions performed by the server system would be apparent to those of skill in the art. Furthermore, some aspects of the present technology may be performed by the server system 120, the client device 240, and the smart device 280 cooperatively.

It should be understood that the operating environment 200 that involves the server system 120, the client device 240, and the smart device 240 is merely an example. Many aspects of operating environment 200 are generally applicable in other operating environments in which a server system provides data processing for monitoring and facilitating review of data captured by other types of electronic devices.

The smart devices, the client devices, and the server system communicate with each other using the one or more communication networks 150. In an example smart work environment 100, two or more devices (e.g., the network interface device 136, the hub device 180, the client devices 240, and the smart devices 204) are located in close proximity to each other, such that they can be communicatively coupled in the same sub-network via wired connections, a WLAN, or a Bluetooth Personal Area Network (PAN). The Bluetooth PAN is optionally established based on classical Bluetooth technology or Bluetooth Low Energy (BLE) technology. In some implementations, each of the hub device 180, the client device 240, and the smart devices 204 are communicatively coupled to the networks 150 via the network interface device 136.

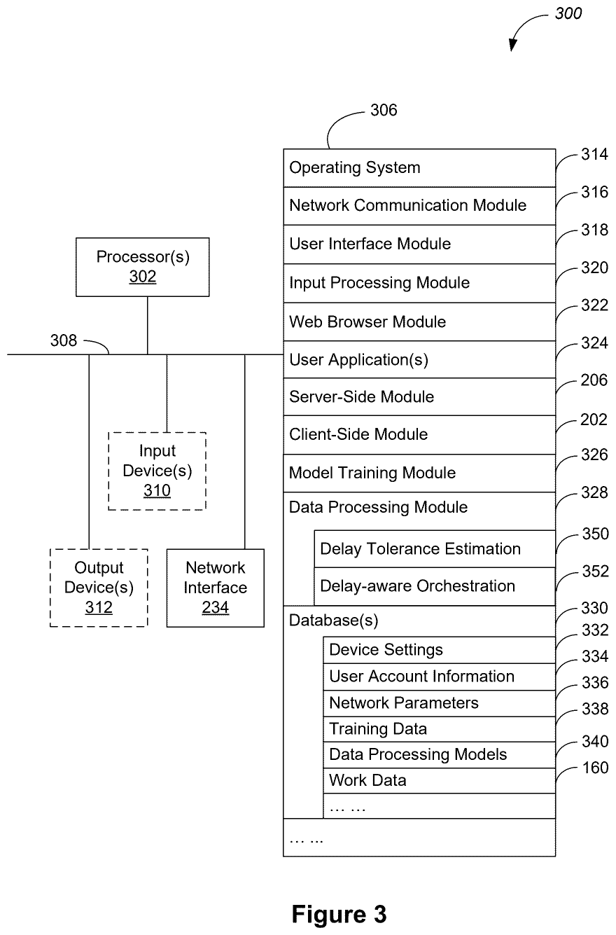

FIG. 3 is a block diagram illustrating a computer system 300 of a smart work environment 100 in accordance with some implementations. The computer system 300 includes a server 120, a client device 240 (e.g., computer device 118, 130, or 134 in FIG. 1), a smart device 280 (e.g., devices 102-114 in FIG. 1), a storage 116, or a combination thereof, and is configured to enable the smart work environment 100. The computer system 300 includes one or more processing units (CPUs) 302, one or more network interfaces 304, memory 306, and one or more communication buses 308 for interconnecting these components (sometimes called a chipset). In some implementations, the computer system 300 includes one or more input devices 310, which facilitate user input, such as a keyboard, a mouse, a voice-command input unit or microphone, a touch screen display, a touch-sensitive input pad, a gesture capturing camera, or other input buttons or controls. In some implementations, the computer system 300 uses a microphone and voice recognition or a camera and gesture recognition to supplement or replace the keyboard. In some implementations, the computer system 300 includes one or more cameras, scanners, or photo sensor units for capturing images. In some implementations, the computer system 300 includes one or more output devices 312, which enable presentation of user interfaces and display content, including one or more speakers and/or one or more visual displays.

The memory 306 includes high-speed random access memory, such as DRAM, SRAM, DDR RAM, or other random access solid state memory devices. In some implementations, the memory 306 includes non-volatile memory, such as one or more magnetic disk storage devices, one or more optical disk storage devices, one or more flash memory devices, or one or more other non-volatile solid state storage devices. In some implementations, the memory 306 includes one or more storage devices remotely located from the processing units 302. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof:
an operating system 314, which includes procedures for handling various basic system services and for performing hardware dependent tasks;
a network communication module 316, which connects the computer system 300 to other devices (e.g., various servers in the server system 120, a client device, or a smart device) via one or more network interfaces 304 (wired or wireless) and one or more networks 150, such as the Internet, other wide area networks, local area networks, metropolitan area networks, and so on;
a user interface module 318, which enables presentation of information (e.g., a graphical user interface for presenting applications, widgets, websites and web pages thereof, and/or games, audio and/or video content) at a client device 118, 130, and 134;
an input processing module 320 for detecting one or more user inputs or interactions from one of the one or more input devices 310 and interpreting the detected input or interaction;
a web browser module 322 for navigating, requesting (e.g., via HTTP), and displaying websites and web pages thereof, including a web interface for logging into a user account associated with a client device 140 or another electronic device, controlling the client or electronic device if associated with the user account, and editing and reviewing settings and data that are associated with the user account;
one or more user applications 324 for execution by the servers 120 (e.g., smart work applications, and/or other web or non-web based applications);
a server-side module 206, which communicates both with smart work environments and with client-side modules 202 and includes a plurality of individual programs, procedures, modules, and/or objects for performing a variety of functions;
a client-side module 202, which communicates with the server-side module 206 in the smart work environment 100 and includes a plurality of individual programs, procedures, modules, and/or objects for performing a variety of functions;
model training module 326 for receiving training data and establishing one or more data processing models 340 for processing work data 160 (e.g., video, image, audio, or textual data) collected by the smart devices 280;
a data processing module 328 for processing work data 160 using data processing models 340, thereby identifying information contained in the work data 160, matching the work data 160 with other data, categorizing the work data 160, or synthesizing related work data 160; and
one or more databases 330 for storing at least data including one or more of:
   device settings 332 including common device settings (e.g., service tier, device model, storage capacity, processing capabilities, communication capabilities, etc.) of the one or more servers 120, client devices, or smart devices;
   user account information 334 for the one or more user applications 324, e.g., user names, security questions, account history data, user preferences, and predefined account settings;
   network parameters 336 for the one or more communication networks 150, e.g., IP address, subnet mask, default gateway, DNS server and host name;
   training data 338 for training one or more data processing models 340;
   data processing model(s) 340 for processing work data 160 (e.g., video, image, audio, or textual data) using deep learning techniques;
   work data 160 and associated results, where the work data 160 is processed using the data processing models 340 remotely at the server 120 or locally at the client device 240 to provide the associated results to be presented on the client devices or further processed.

In some implementations, the server-side module 106 acts as a control layer or API to the underlying functionality. In some implementations, the server-side module includes one or more of an emitter modulation module, a signal detection module, an object detection module, a location module, a movement module, a depth mapping module, and/or a gesture determination module for a smart device 280. Some implementations implement all of these features at a server system 120, some implementations implement all of these features at the camera 110, and some implementations distribute the functionality between the server 120 and the imaging device (e.g., based on efficiency considerations). In some implementations, the server-side module 206 includes a response processing module, which receives either raw unprocessed signals received at an camera 110 or signals that have been preprocessed by a local response processing module at the camera 110. The response processing module prepares the work data 160 (e.g., time of flight detection data) for use by the location module, the movement module, the depth mapping, and/or the gesture determination module. The server-side module 206 also includes an account administration module, which enables users to set up smart work environments 100 and to identify the smart devices 204 associated with the smart work environment 100.

In some embodiments, the data processing module 328 includes a delay tolerance estimation module 350 for determining a delay tolerance of one or more processes of an AI pipeline and a delay-aware orchestration module 352 for managing data pipelines. More details on the modules 350 and 352 are discussed below with reference to 6-8D.

Although many aspects of the present technology are described from the perspective of a computer system as a whole, the corresponding actions performed by the client device 240 and/or the server system 120 would be apparent to those of skill in the art. The server-side module 206 and the client-side module 202 are implemented at the server 120 and the client device 240, respectively. Each of the other modules 314-328 may be implemented in any of a server 120, a client device 240 (e.g., computer device 118, 130, or 134 in FIG. 1), a smart device 280 (e.g., devices 102-114 in FIG. 1), a storage 116, or a combination thereof.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules, or data structures, and thus various subsets of these modules may be combined or otherwise rearranged in various implementations. In some implementations, the memory 306 stores a subset of the modules and data structures identified above. In some implementations, the memory 306 stores additional modules and data structures not described above.

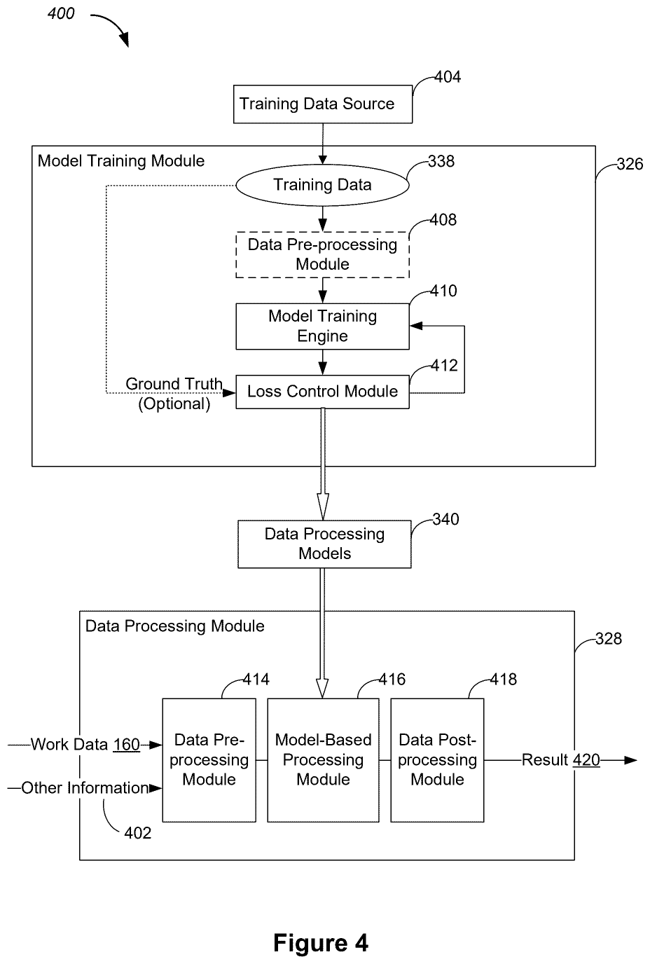

FIG. 4 is a block diagram of a machine learning system 400 for training and applying data processing models 340 using machine learning, in accordance with some embodiments. The machine learning system 400 includes a model training module 326 establishing one or more data processing models 340 and a data processing module 328 for processing data collected by smart devices 280 (e.g., cameras 110) using the data processing model 340. In some embodiments, both the model training module 326 (e.g., the model training module 326 in FIG. 3) and the data processing module 328 are located in the server 120, while a training data source 404 provides training data 338 to the server 120. In some embodiments, the training data source 404 is the data obtained from the smart devices 280, from another server 120, from storage 106, or from a client device. Alternatively, in some embodiments, the model training module 326 (e.g., the model training module 326 in FIG. 3) is located at a server 120, and the data processing module 328 is located in a smart device 280 or a client device 240. The server 120 trains the data processing models 328 and provides the trained models 340 to a smart device 280 or a client device 240 to process real-time work data 160 captured by the smart device 280.

In some embodiments, the training data 338 provided by the training data source 404 include a standard dataset (e.g., a set of work site images) widely used by engineers in an associated industry to train data processing models 340. In some embodiments, the training data 338 includes work data 160 and/or additional work site information, which is collected from one or more smart devices that will apply the data processing models 340 or collected from distinct smart devices that will not apply the data processing models 340. Further, in some embodiments, a subset of the training data 338 is modified to augment the training data 338. The subset of modified training data is used in place of or jointly with the subset of training data 338 to train the data processing models 340.

In some embodiments, the model training module 326 includes a model training engine 410, and a loss control module 412. Each data processing model 340 is trained by the model training engine 410 to process corresponding work data 160. Specifically, the model training engine 410 receives the training data 338 corresponding to a data processing model 340 to be trained, and processes the training data to build the data processing model 340. In some embodiments, during this process, the loss control module 412 monitors a loss function comparing the output associated with the respective training data item to a ground truth of the respective training data item. In these embodiments, the model training engine 410 modifies the data processing models 340 to reduce the loss, until the loss function satisfies a loss criteria (e.g., a comparison result of the loss function is minimized or reduced below a loss threshold). The data processing models 340 are thereby trained and provided to the data processing module 328 to process work data 160.

In some embodiments, the model training module 326 further includes a data pre-processing module 408 configured to pre-process the training data 338 before the training data 338 is used by the model training engine 410 to train a data processing model 340. For example, an image pre-processing module 408 is configured to format images in the training data 338 into a predefined image format. For example, the preprocessing module 408 may normalize the images to a fixed size, resolution, or contrast level. In another example, an image pre-processing module 408 extracts a region of interest (ROI) corresponding to a target area or object in each image or separates content of the target area or object into a distinct image.

In some embodiments, the model training module 326 uses supervised learning in which the training data 338 is labelled and includes a desired output for each training data item (also called the ground truth in some situations). In some embodiments, the desirable output is labelled manually by people or labelled automatically by the model training model 326 before training. In some embodiments, the model training module 326 uses unsupervised learning in which the training data 338 is not labelled. The model training module 326 is configured to identify previously undetected patterns in the training data 338 without pre-existing labels and with little or no human supervision. Additionally, in some embodiments, the model training module 326 uses partially supervised learning in which the training data is partially labelled.

In some embodiments, the data processing module 328 includes a data pre-processing module 414, a model-based processing module 416, and a data post-processing module 418. The data pre-processing modules 414 pre-processes work data 160 based on the type of the work data 160. In some embodiments, functions of the data pre-processing modules 414 are consistent with those of the pre-processing module 408, and convert the work data 160 into a predefined data format that is suitable for the inputs of the model-based processing module 416. The model-based processing module 416 applies the trained data processing model 340 provided by the model training module 326 to process the pre-processed work data 160. In some embodiments, the model-based processing module 416 also monitors an error indicator to determine whether the work data 160 has been properly processed in the data processing model 340. In some embodiments, the processed work data is further processed by the data post-processing module 418 to create a preferred format or to provide additional work information, associated with the smart work environment 100, which can be derived from the processed work data.

In some embodiments, work data 160 are supplemented with other information 402 (e.g., additional work site information, which is collected from one or more smart devices that will apply the data processing models 340 or collected from distinct smart devices that will not apply the data processing models 340). In some embodiments, the data processing module 328 uses the processed work data (e.g., result 420) to at least partially autonomously control an equipment or tool (e.g., forklift 126 in FIG. 1) that operates in the smart work environment 100. For example, the processed work data includes control instructions that are used by a control system (manned or unmanned) to drive the forklift 126. In some embodiments, the processed work data (e.g., result 420) is applied to at least partially autonomously control a robot operating on a vehicle assembly line or in an electronics manufacturing facility.

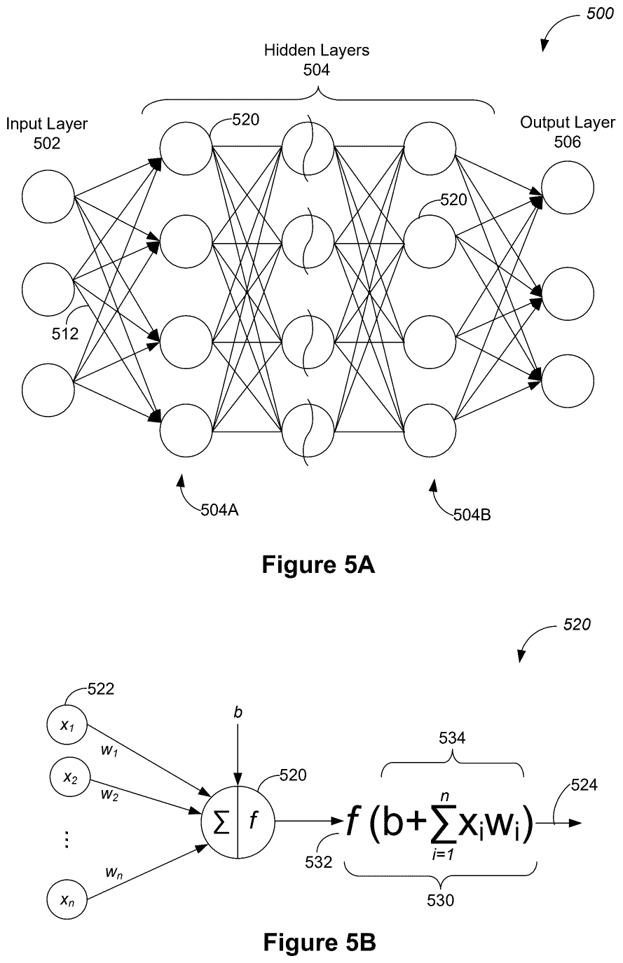

FIG. 5A is a structural diagram of an example neural network 500 applied to process work data in a data processing model 340, in accordance with some embodiments, and FIG. 5B is an example node 520 in the neural network 500, in accordance with some embodiments. It should be noted that this description is used as an example only, and other types or configurations may be used to implement the embodiments described herein. The data processing model 340 is established based on the neural network 500. A corresponding model-based processing module 416 applies the data processing model 340 including the neural network 500 to process work data 160 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w₁, w₂, w₃, and w₄ according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a data processing model 340 to process work data (e.g., video and image data captured by cameras 110). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the data processing model 340 to process work data 160. Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of work data are processed by the data processing module 328, and two or more types of neural networks (e.g., both a CNN and an RNN) are applied in the same data processing model 340 to process the work data jointly.

The training process is a process for calibrating all of the weights wᵢ for each layer of the neural network 500 using training data 338 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the weighted outputs 534 from the previous layer before the activation function 532 is applied. The network bias b provides a perturbation that helps the neural network 500 avoid over fitting the training data. In some embodiments, the result of the training includes a network bias parameter b for each layer.

FIG. 6 is a flow diagram of an example process of managing a plurality of data paths associated with a warehousing application (e.g., user application(s) 324), in accordance with some embodiments. In some embodiments, the warehousing application is implemented in conjunction with a physical environment, such as a warehouse environment shown in FIG. 1, which includes one or more forklifts 126 that load and unload boxes 610 in the physical environment. The physical environment includes one or more cameras 110 that are configured to monitor, detect, and capture events and identify defects in the boxes 610. The process 600 is implemented by a computer system (e.g., computer system 300) that includes one or more processors (e.g., processor(s) 302). In some embodiments, the processors can comprise different processor types such as central processing unit (CPU) 602, integrated graphics processing unit (iGPU) 604, and general purpose graphics processing unit (GPGPU) 606, or a tensor processing unit (TPU). In some embodiments, the processors can be located on the same device or on multiple devices that are part of the same computing cluster.

In some embodiments, camera data 614 (e.g., video data, image data, and/or audio data) that is acquired by the one of more cameras 110 undergoes one or more image preprocessing steps 616 to generate preprocessed data 617. The image preprocessing can include resizing and cropping image or video frames, or applying one or more filters to the frames so as to protect the privacy of human subjects that are present in the camera data 614.

In some embodiments, the preprocessed data 617 is fed into a processing pipeline 660 that is executed by iGPU 604 and GPGPU 606. For example, FIG. 6 shows that the iGPU 604 performs data processing operations such as decoding 618, color space conversion 620 (e.g., to change the values of the pixels to a different color schema) and resizing 624 from the preprocessed data 617 to generate intermediate 625.

In some embodiments, the intermediate data 625 is input into an inferencing pipeline 662 that is implemented by GPGPU 606. In some embodiments, the inferencing pipeline 662 includes a plurality of data paths 664 for processing the intermediate data 625, such as a first data path (data path 1 664-1) and a second data path (data path 2 664-2). In some embodiments, the GPGPU 606 applies one or more data processing models (e.g., data processing models 340) successively or in parallel to process the intermediate data 625.

In some embodiments, each of the data paths 664 has a respective latency requirement (e.g., a time requirement for data to travel through the data path). In some embodiments, each of the data paths has a respective priority designation (e.g., high, medium, or low priority).

Using the warehouse environment as an example, in some embodiments, the GPGPU 606 executes the first data path 664-1 to determine whether a respective box 610 is defective, and executes the second data path 664-2 to determine whether a barcode on respective non-defective box 610 is readable or not. To this end, for the first data path 664-1, the GPGPU 606 can perform image segmentation 626 on respective frame (e.g., an image) in the intermediate data 625, to obtain one or more frame segments corresponding to the respective frame. Following the image segmentation, the GPGPU 606 is configured to perform object detection (628) on a frame segment (e.g., image segment), to determine whether the respective frame segment includes one or more boxes (found 630). When the GPGPU 606 determines that a frame segment includes one or more boxes, the GPGPU can perform image classification (632) on the frame segment, to determine whether the frame segment includes one or more boxes that are defective. In some embodiments, the classification result 666 is transmitted into a business logic unit 642 that is executed by CPU 602. For example, in some embodiments, the business logic unit 642 is configured to output a decision to accept a respective box when the classification result 666 for the frame segment indicates that the respective box in the frame segment as a non-defective box. In some embodiments, the business logic unit 642 is configured to output a decision to reject a respective box when the classification result 666 for the frame segment classifies the respective box in the frame segment as a defective box. In some embodiments, when the business logic unit 642 outputs a decision to reject a respective box for being defective, the business logic unit 642 can send an instruction to the forklift 126 to physically move the defective box to another location in the warehouse. In response to the instruction, the forklift 126 may be controlled to, or automatically, drive to the other location in the warehouse.

In some embodiments, when the image classification result for the frame segment classifies a respective box as a non-defective box, the frame segment is transmitted to a second data path 664-2 that is configured to determine whether a barcode on the non-defective box is readable. To this end, in some embodiments, the GPGPU 606 executes a “crop object 634” operation on the frame segment, to crop the frame segment to a smaller-sized cropped segment, corresponding to a position of the barcode. The GPGPU 606 performs object detection (636) on the cropped segment to determine (638) whether the barcode can be found (638), and performs a classification operation (640) that generates a classification result 668 for indicating whether the barcode is readable or not readable. In some embodiments, the GPGPU 606 transmits the classification result 668 to the business logic unit 642, where the business logic unit 642 is configured to execute a task request to print a replacement barcode when the classification result 668 indicates that the barcode is not readable. In some embodiments, the business logic unit 642 is configured to take no further action when the classification result 668 indicates that the barcode is readable.

With continued reference to FIG. 6, in some embodiments, the business logic 642 is configured to perform functions such as storing 644, publishing 646, or generating and rendering dashboards that include visualizations 648.

In some embodiments, the processing pipeline 650 is communicatively connected to a database 650 that stores data generated by the processing pipeline 660 (e.g., by iGPU 604, GPGPU 606, and CPU 602). In some embodiments, the database 650 is implemented using an intelligent solid state drive (SSD) 670 that is configured to perform selective data identification to determine variability of a respective data path over time. For example, in some implementations, after each frame segment is cropped (operation 634), a respective cropped segment is stored in the intelligent SSD 670. The intelligent SSD 670 is configured to include a memory-side data processor that processes the respective cropped segment locally on the SSD 670, e.g., to generate a label for the respective cropped segment and store the label jointly with the respective cropped segment in the SSD 670. In an example, the label of each cropped segment is selected from a plurality of predefined labels.

In some embodiments, different parts of the pipeline are better suited for certain kind of compute. For example, a resize can run efficiently on a co-processor, and deep learning functions such as object detection are best executed on a GPGPU. When such a use case is deployed at scale at the edge, this installation can span hundreds of nodes with many instances operating on multiple parts of the physical environment. For example, in a factory, a plurality of copies of this pipeline (e.g., each corresponding to respective one or more cameras) are deployed and managed.

In some embodiments, a pipeline includes a time-sensitive operation (e.g., which requires an answer under 100 milliseconds), a delay-tolerant operation (e.g., which can tolerate delays often in the order of minutes or hours), or both. Using an assembly line as an example, in some embodiments, the time-sensitive operation includes detection of one or more defects on the assembly line, and is processed by a time-sensitive module. In some embodiments, the delay-tolerant operation is processed by a delay-tolerant module, and includes application of a predictive maintenance model that is configured to predict whether failure of an assembly line robot may occur during the following day.

In accordance with at least some embodiments disclosed herein is the realization that, when pipeline management are performed using a manageability framework, containers are deployed without differentiating the time-sensitive operations from the delay-tolerant operation and cannot provide efficient solutions because these frameworks are not designed to understand or determine whether some parts of an AI pipeline may be delay-tolerant. Conversely, in some embodiments, there is no assumption that all parts of the pipeline are either completely delay-tolerant or completely delay-intolerant (i.e., requiring real-time response), thereby improving efficiency of the process 600 in terms of resource utilization.

In some embodiments, the computer system includes a delay tolerance estimation module 350 for monitoring delays of a plurality of data paths, which correspond to different pipeline operations, and a delay-aware orchestration module 352 for dynamically allocating resources (e.g., processing resources) based on the monitored delays. In some embodiments, the delay-aware orchestration module 352 acts as an orchestrator of a plurality of data paths implemented by the plurality of pipelines with the help of the delay tolerance estimation module 350.

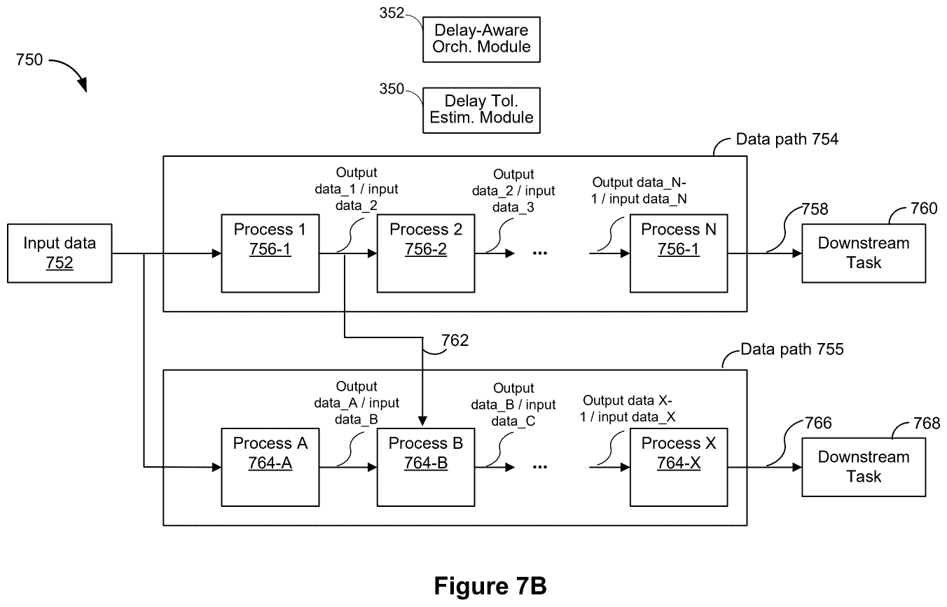

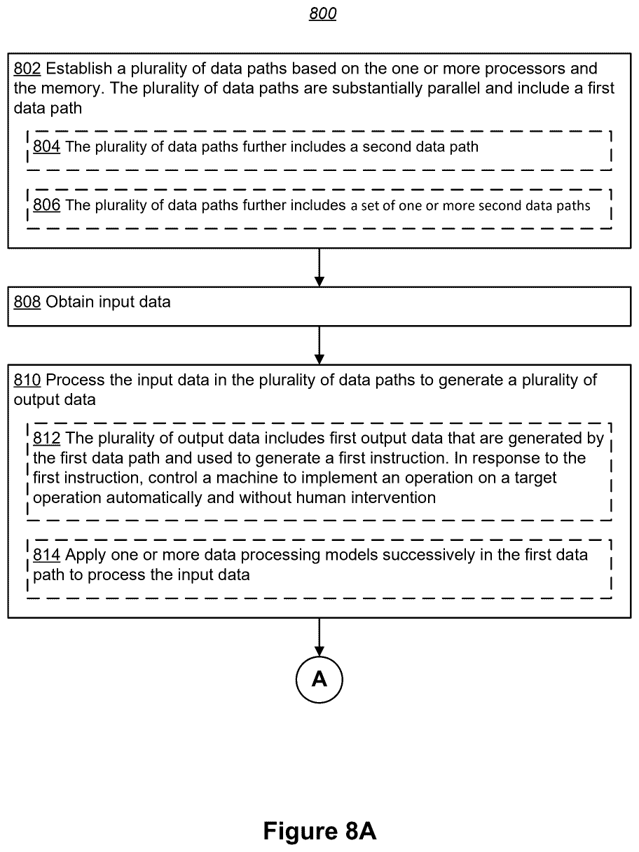

FIGS. 7A and 7B illustrate exemplary data path scenarios, in accordance with some embodiments.

FIG. 7A illustrates a scenario 700 where one or more processors (e.g., processor(s) 302) of a computer system (e.g., computer system 300) establish data paths 702 and 703 for processing input data 704. In some embodiments, a data path is also known as a processing pipeline or an AI pipeline. In some embodiments, data path 702 and data path 703 are substantially parallel and process the input data 704 concurrently (e.g., in parallel). Data path 702 includes N sequential processes 706-1 to 706-N for processing the input data 704. Data that is output by a respective process 706 constitutes input data for a subsequent process in the data path 702. For example, FIG. 7A shows that data output by process 1 706-1 constitutes the input data for process 2 706-2 (i.e., output data_1=input data_2). Data path 702 generates output data 708 that is used to generate instructions for performing downstream task 710. Data path 703 includes X sequential processes 712-A to 712-X. Data that is output by a respective process 712 constitutes input data for a subsequent process in the data path 703. Data path 703 generates output data 714 that is used for performing downstream task 716.

FIG. 7B illustrates a scenario 750 where one or more processors (e.g., processor(s) 302) of a computer system (e.g., computer system 300) establish data paths 754 and 755 for processing input data 752. Data path 754 includes N sequential processes 756-1 to 756-N. Data path 755 includes X sequential processes 764-A to 764-X. In the example of FIG. 7B, process 1 756-1 generates data output 762 that is used as input by process 2 756-2 of data path 754 as well as by process B 764-B of data path 755. Data path 754 generates output data 758 that is used for performing downstream task 760. Data path 755 generates output data 766 that is used for performing downstream task 768.

In the example of FIG. 7B, a delay in the process 756-1 can lead to delays in the downstream processes of the data path 754, but can also lead to delays in the processes of data path 755.

According to some embodiments of the present disclosure, the computer system includes a delay tolerance estimation module 350 that is configured to determine a delay tolerance of an AI pipeline. As illustrated in FIGS. 7A and 7B, a respective process (e.g., process 706, 712, 756, or 764) in a data path (e.g., data path 702, 703, 754 or 755) has input data and output data. In some embodiments, the output data of a respective process comprises a message that includes images and other artifacts such as model output presented as metadata. An example of a model output is whether a defect was found in an object (the output of a classification). In some embodiments, the computer system monitors for the occurrence of the output and associates it with the process (or the module or model performing the process). In some embodiments, the computer system combines the output with other outputs and presents to a user by rendering the output (or combined output) in a graphical user interface (GUI). In some instances, if the GUI (or any other way of consuming the output) is deployed on a different node and the orchestrator does not have access to these containers and devices, then it would be very difficult if not impossible to estimate the delay tolerance.

It should be understood that image data applied to describe the scenarios 700 and 750 are merely exemplary and are not intended to indicate that data processed by the data paths 702, 703, 754, and 755 are limited to image data. One of ordinary skill in the art would recognize various types of data (e.g., video data, audio data, text data, metadata, sensor data, or a combination thereof) may be processed by the data paths 702, 703, 754, and 755 as described herein.

In some embodiments, the delay tolerance estimation module 350 is configured to detect/estimate the delay tolerance when an output reaches a user, such as in the business logic unit 642 as illustrated in FIG. 6. In some embodiments, if the delay tolerance estimation module 350 does not have visibility as to how the user reacts to the output presented to them, its estimate of the delay tolerance may be less accurate since a user can be presented with a stream of module outputs [O1, O2, O3, . . . ] while these streams continue to be shown on a screen simultaneously. In this situation, when a user reacts by clicking on a button or initiating an action, the delay tolerance estimation module 350 may not be able to accurately determine which of the outputs the user is reacting to. In some embodiments, in instances like this, the delay tolerance estimation module 350 is configured to estimate the time delay as though it is the worst case scenario and that they needed the information presented in the most recent output O3, for example. In this scenario, the delay tolerance estimation module 350 can measure the time from the moment O3 was generated to when a user reacted to it. In some embodiments, the measured time is the estimated delay for that process. In some embodiments, the delay tolerance estimation module 350 is configured to monitor the process for few more outputs before deciding whether it can delay running the process, or whether resources (e.g., output data) are needed elsewhere (e.g., an outlier was encountered).

In some embodiments, the delay tolerance estimation module 350 is configured to determine whether an output of a data path is needed by another process (or module) that is more delay sensitive. Referring to FIG. 6 as an example, suppose that the output of object detection 628 (e.g., performed by an object detection module or data processing models 340) and the output classification 632 (e.g., performed by a classification module or data processing models 340) are consumed by two separate user interfaces. The delay tolerance estimation module 350 may observe that the output of the object detection module is substantially delay tolerant (e.g., allows a delay up to a substantially large delay threshold) and is consumed within a minimum of 30 minutes. However, the output of the “classification” module is consumed once every two minutes. The classification module uses the output of the object detection module, and delays in the output of the object detection module would lead to delays in the classification module and break the requirement that the output of the classification module is consumed every two minutes.

Note that the same can also happen if the computer system is sending the output to a machine rather than a human. For example, in some embodiments, if the computer system is sending the output to a robotic arm, the delay tolerance estimation module 350 can monitor whether the output is consumed.

In some embodiments, more proactive approaches can be adopted in certain environments. For example, the delay tolerance estimation module 350 can delay the output of a certain process (or module) and monitor the rest of the pipeline to see if a delay or other service level agreement (SLA) deterioration is observed. In some embodiments, the delay tolerance estimation module 350 is configured to delay the output in a test or live system. If no deterioration is observed, then more delay can be introduced until a disruption is observed. When this happens, the computer system can roll back to the least known good configuration with no deterioration. In some embodiments, if a human is in the loop, meaning that the outputs are consumed in a human facing GUI, then the computer system can request for a response from the human to determine whether a delay is acceptable. In some embodiments, the computer system includes sensors or gaze tracking mechanisms, which can be used to determine whether the human looks at or interacts with a piece of data. In some embodiments, the computer system is configured to use the sensor or gaze tracking data to learn the needed latency and what would be tolerable.

In some embodiments, the computer system includes a delay-aware orchestration module 352 that is configured to manage AI pipelines. In situations where the delay requirement for each of the processes of a respective data flow is known, the delay can be predicted/estimated using the delay estimation tolerance module 350 or entered explicitly by a human operator. In some embodiments, the delay needs to account for the latency of running the process itself. For example, the inference can run on a specific hardware configuration in 30 milliseconds, and the answer is needed within 2 seconds of an event occurring. The delay tolerance is 2 seconds. The time we can delay running the inference is 1970 milliseconds, which is equal to 2000 milliseconds minus 30 milliseconds, or else the computer system would not be able to deliver the result on time.

In some embodiments, the delay-aware orchestration module 352 is configured to manage a pipeline density to efficiently utilize available hardware and ensure time critical steps are completed within the given tolerance.

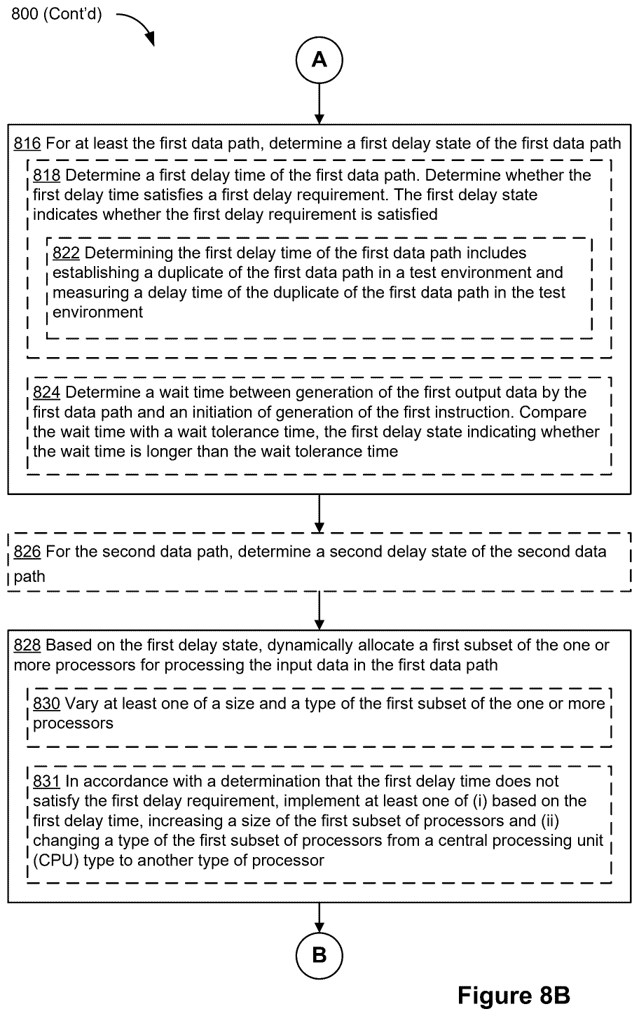

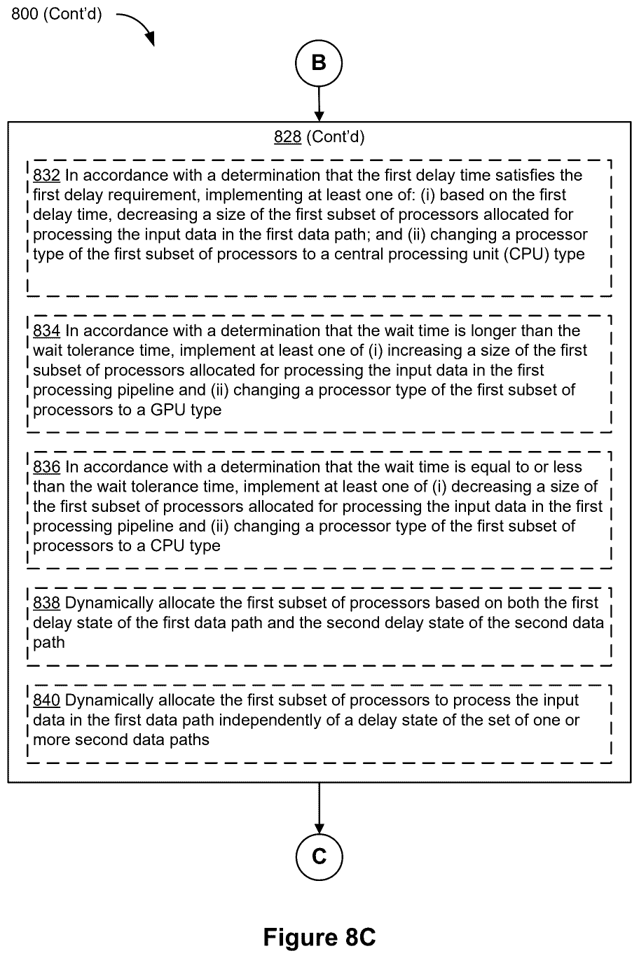

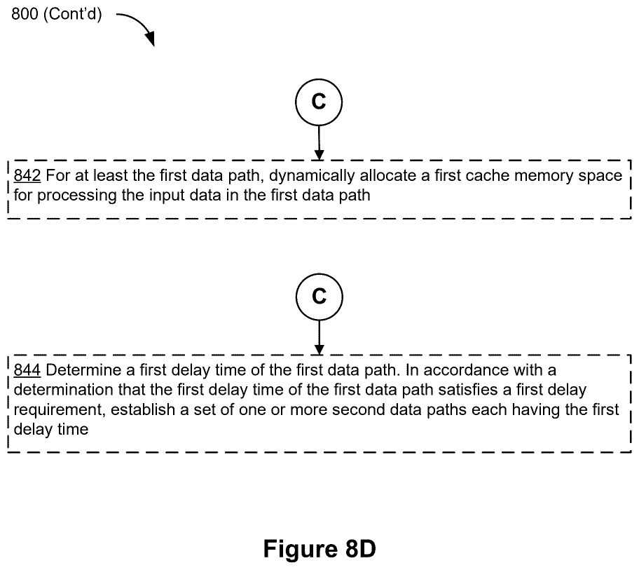

FIGS. 8A to 8D provide a flowchart of an example process for processing data, in accordance with some embodiments. The method 800 is performed at a computer system (e.g., computer system 300).

The computer system includes one or more processors (e.g., processor(s) 302 in FIG. 3) and memory (e.g., memory 306). In some embodiments, the one or more processors comprise a plurality of processors corresponding to a plurality of processor types, such as CPU (e.g., CPU 602), GPU (e.g., iGPU 604 or GPGPU 606), or TPU. In some embodiments, the memory stores one or more programs or instructions configured for execution by the one or more processors. In some embodiments, the operations shown in FIGS. 1, 2, 4, 5A, 5B, 6, 7A, and 7B correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 800 may be combined. The order of some operations may be changed.

Referring to FIG. 8A, the computer system establishes (operation 802) a plurality of data paths (e.g., data paths 664-1, 664-2, 702, 703, 754, or 755) based on the one or more processors and the memory. The plurality of data paths are substantially parallel (e.g., at least partially parallel) and includes a first data path (e.g., data path 702 in FIG. 7A, data path 754 in FIG. 7B). In some embodiments, a data path is also known as a processing pipeline or an AI pipeline.

In some embodiments, the plurality of data paths further includes (operation 804) a second data path (e.g., data path 703 in FIG. 7A, data path 755 in FIG. 7B). In some embodiments, the plurality of data paths further includes (operation 806) a set of one or more second data paths.

The computer system obtains (operation 808) input data (e.g., input data 704 in FIG. 7A, data path 754 in FIG. 7B).

The computer system processes (operation 810) the input data in the plurality of data paths to generate a plurality of output data (e.g., output data 708 and 714 in FIG. 7A, output data 758 and 766 in FIG. 7B). In some embodiments, each of the data paths uses the same input data (e.g., as illustrated in FIGS. 7A and 7B).

In some embodiments, the plurality of output data includes (operation 812) first output data (e.g., output data 708 in FIG. 7A, output data 758 in FIG. 7B) that are generated by the first data path and used to generate a first instruction. For example, FIG. 7A illustrates that data path 702 generates output data 708 that is used to generate instructions for performing downstream task 710. The computer system, in response to the first instruction, controls a machine to implement an operation (e.g., a physical action) on a target operation automatically and without human intervention. Examples of controlling a machine include, and are not limited to, controlling a forklift (e.g., forklift 126) to physically lift a box (e.g., boxes 610) and move it to a target destination in a warehouse setting, as illustrated in FIG. 6, or controlling a machine to move a defective box to another part of the warehouse.

In some embodiments, processing the input data in the plurality of data paths to generate the plurality of output data includes applying (operation 814) one or more data processing models (e.g., data processing models 340) successively in the first data path to process the input data.

Referring to FIG. 8B, the computer system, for at least the first data path, determines (operation 816) a first delay state of the first data path. For example, in some embodiments, the first data path generates a first output that is used (e.g., by the CPU 602) to perform business logic operations (e.g., rule-based operations, such as publishing, storing, or visualizing operations), as illustrated in FIG. 6. In some embodiments, the first delay state includes a state where a business logic operation ready to be executed but is waiting for an output of the first data path before it can be executed. In some embodiments, the first delay state includes a state where a first output of the first data path has been generated, but the business logic operation is not performed until a subsequent time (e.g., 2 hours later or one day later).

In some embodiments, determining the first delay state of the first data path includes determining (operation 818) a first delay time of the first data path; and determining whether the first delay time satisfies a first delay requirement (e.g., whether the first delay requirement is satisfied or not; whether the first delay requirement satisfies a first delay threshold, or how the first delay requirement compares with previous processing times). The first delay state indicates whether the first delay requirement is satisfied.

In some embodiments, determining the first delay time of the first data path includes establishing (operation 822) a duplicate of the first data path in a test environment (e.g., the test environment is distinct from an environment in which the plurality of data paths are established); and measuring a delay time of the duplicate of the first data path in the test environment. For example, in some embodiments, the computer system deploys two copies of the first data path, one customer facing and the other in a test environment, and measures the delay time using the pipeline in the test environment.

In some embodiments, determining the first delay state of the first data path includes determining (operation 824) a wait time between generation of the first output data by the first data path and an initiation of generation of the first instruction and comparing the wait time with a wait tolerance time, the first delay state indicating whether the wait time is longer than the wait tolerance time.

In some embodiments, the computer system, for the second data path, determines (operation 826) a second delay state of the second data path.

The computer system, based on the first delay state, dynamically allocates (operation 828) a first subset of the one or more processors for processing the input data in the first data path.

In some embodiments, dynamically allocating the first subset of the one or more processors for processing the input data in the first data path includes varying (operation 830), by the computer system, at least one of a size and a type of the first subset of the one or more processors. In some embodiments, the size of the processors may be varied by a default size, gradually, or incrementally. In some embodiments, the size of the first subset of processors is measured by a number of processing cores, and increases from a first number of processing cores to a second number of processing cores (e.g., from 2 to 3 or from 3 to 2 cores out of a total number of cores). In some embodiments, a size of a cache associated with the first subset of processors is varied. In some embodiments, a type of the first subset of processors varies from the CPU to the GPU or from the GPU to the CPU. For example, in accordance with a determination that the first data path is substantially sensitive to a delay, the first data path is implemented at the GPU.

In some embodiments, dynamically allocating a first subset of the one or more processors includes, in accordance with a determination by the computer system that the first delay time does not satisfy the first delay requirement, implementing (operation 831) at least one of: (i) based on the first delay time, increasing a size of the first subset of processors; and (ii) changing a type of the first subset of processors from a central processing unit (CPU) type to another type of processor, such as a GPU type or TPU type, e.g., enhancing the first delay time to satisfy the first delay requirement. In other ways, the corresponding data path does not satisfy its associated first delay requirement and needs to be prioritized, e.g., compared with a different data path, which satisfies an associated delay requirement.

Referring to FIG. 8C, in some embodiments, dynamically allocating a first subset of the one or more processors includes, in accordance with a determination by the computer system that the first delay time satisfies the first delay requirement, implementing (operation 832) at least one of: (i) based on the first delay time, decreasing a size of the first subset of processors allocated for processing the input data in the first data path; and (ii) changing a processor type of the first subset of processors to a central processing unit (CPU) type (from a graphical processing unit (GPU) type, a TPU type, or another processor type). In other ways, the corresponding data path satisfies the first delay requirement and has a margin to be de-prioritized, e.g., compared with a different data path, which might have failed an associated delay requirement.

In some embodiments, dynamically allocating the first subset of the one or more processors includes, in accordance with a determination by the computer system that the wait time is longer than the wait tolerance time (e.g., meaning that a subsequent process is waiting for the output data), implementing (operation 834) at least one of increasing a size of the first subset of processors allocated for processing the input data in the first data path (e.g., increasing by a default size, increasing incrementally, or increasing gradually) and changing a processor type of the first subset of processors to a GPU type (e.g., from a CPU type). Stated another way, the subsequent process is waiting, and therefore, the corresponding data path needs to be prioritized, e.g., compared with a different data path that does not delay its associated subsequent process.

In some embodiments, dynamically allocating the first subset of the one or more processors includes, in accordance with a determination by the computer system that the wait time is equal to or less than the wait tolerance time (e.g., meaning that the next step or process is not waiting for the output), the computer system implements (operation 836) at least one of decreasing a size of the first subset of processors allocated for processing the input data in the first data path; and changing a processor type of the first subset of processors to a CPU type. Stated another way, the corresponding data path has a margin to be de-prioritized, e.g., compared with a different data path that delays its associated subsequent process.

In some embodiments, the computer system dynamically allocates (operation 838) the first subset of processors based on both the first delay state of the first data path and the second delay state of the second data path. For example, in some embodiments, the first subset of processors is dynamically allocated according to a respective priority level of a data path. In some embodiments, if the second data path has a higher priority than the first data path, more resources may be directed to the second data path, in accordance with the second delay state of the second data path, even though the first data path is delayed. For example, the first and second data paths are interconnected (e.g., an output of the second data path is used as input to the first data path).

In some embodiments, the computer system dynamically allocates (operation 840) the first subset of processors for processing the input data in the first data path independently of a delay state of the set of one or more second data paths. For example, in some embodiments, the computer system prioritizes the first data path as long as its first delay requirement is not satisfied.)

Referring to FIG. 8D, in some embodiments, the computer system, for at least the data path, dynamically allocates (operation 842) a first cache memory space for processing the input data in the first data path.

In some embodiments, the computer system determines (operation 844) a first delay time of the first data path. In accordance with a determination that the first delay time of the first data path satisfies a first delay requirement, the computer system establishes a set of one or more second data paths each having the first delay time. For example, in some embodiments, the computer system is configured to deploy multiple (e.g., duplicative) data paths. The computer system is configured to, after determining the optimum delay time for one pipeline, deploy the remaining ones each having the optimum delay time.

It should be understood that the particular order in which the operations in FIG. 8 have been described are merely exemplary and are not intended to indicate that the described order is the only order in which the operations could be performed. One of ordinary skill in the art would recognize various ways to processing data and managing resources for different data paths as described herein. Additionally, it should be noted that details of other processes described herein with respect to other figures (e.g., FIGS. 1-7B) are also applicable in an analogous manner to method 800 described above with respect to FIGS. 8A-8D. For brevity, these details are not repeated here.

Turning on to some example embodiments:
(A1) In accordance with some embodiments, a method for processing data is performed at a computer system having one or more processors and memory. The method includes establishing a plurality of data paths based on the one or more processors and the memory. The plurality of data paths being substantially parallel and including a first data path. The method includes obtaining input data and processing the input data in the plurality of data paths to generate a plurality of output data. The method includes, for at least the first data path: determining a first delay state of the first data path; and based on the first delay state, dynamically allocating a first subset of the one or more processors for processing the input data in the first data path.
(A2) In some embodiments of A1, the method further includes: for at least the first data path, dynamically allocating a first cache memory space for processing the input data in the first data path.
(A3) In some embodiments of A1 or A2, dynamically allocating the first subset of the one or more processors for processing the input data in the first data path further includes varying at least one of a size and a type of the first subset of the one or more processors.
(A4) In some embodiments of any of A1-A3, wherein determining the first delay state of the first data path further comprises: determining a first delay time of the first data path; and determining whether the first delay time satisfies a first delay requirement, the first delay state indicating whether the first delay requirement is satisfied.
(A5) In some embodiments of A4, dynamically allocating a first subset of the one or more processors further comprises, in accordance with a determination that the first delay time does not satisfy the first delay requirement, implementing at least one of: (i) based on the first delay time, increasing a size of the first subset of processors; and (ii) changing a type of the first subset of processors from a central processing unit (CPU) type to another type of processor.
(A6) In some embodiments of A4 or A5, wherein dynamically allocating a first subset of the one or more processors further comprises, in accordance with a determination that the first delay time satisfies the first delay requirement, implementing at least one of: (i) based on the first delay time, decreasing a size of the first subset of processors allocated for processing the input data in the first data path; and (ii) changing a processor type of the first subset of processors to a central processing unit (CPU) type.
(A7) In some embodiments of any of A4-A6, determining the first delay time of the first data path includes: establishing a duplicate of the first data path in a test environment; and measuring a delay time of the duplicate of the first data path in the test environment.
(A8) In some embodiments of any of A1-A7, the plurality of output data includes first output data that are generated by the first data path and used to generate a first instruction. The method further includes. in response to the first instruction, controlling a machine to implement an operation on a target operation automatically and without human intervention.
(A9) In some embodiments of A8, determining the first delay state of the first data path further comprises: determining a wait time between generation of the first output data by the first data path and an initiation of generation of the first instruction; and comparing the wait time with a wait tolerance time, the first delay state indicating whether the wait time is longer than the wait tolerance time.
(A10) In some embodiments of A9, dynamically allocating the first subset of the one or more processors further comprises, in accordance with a determination that the wait time is longer than the wait tolerance time, implementing at least one of: (i) increasing a size of the first subset of processors allocated for processing the input data in the first data path; and (ii) changing a processor type of the first subset of processors to a GPU type.
(A11) In some embodiments of A9 or A10, dynamically allocating the first subset of the one or more processors further comprises, in accordance with a determination that the wait time is equal to or less than the wait tolerance time, implementing at least one of: (i) decreasing a size of the first subset of processors allocated for processing the input data in the first data path; and (ii) changing a processor type of the first subset of processors to a CPU type.
(A12) In some embodiments of any of A1-A11, processing the input data in the plurality of data paths to generate the plurality of output data further includes: applying one or more data processing models successively in the first data path to process the input data.
(A13) In some embodiments of any of A1-A12, the plurality of data paths further includes a second data path. The method includes, for the second data path, determining a second delay state of the second data path. The first subset of processors is dynamically allocated based on both the first delay state of the first data path and the second delay state of the second data path.
(A14) In some embodiments of any of A1-A13, the plurality of data paths further includes a set of one or more second data paths, and the first subset of processors is dynamically allocated for processing the input data in the first data path independently of a delay state of the set of one or more second data paths.
(A15) In some embodiments of any of A1-A14, the method further includes: determining a first delay time of the first data path; and in accordance with a determination that the first delay time of the first data path satisfies a first delay requirement, establishing a set of one or more second data paths each having the first delay time.
(B1) In accordance with some embodiments, a computer system includes one or more processors and memory. The memory stores one or more programs for execution by the one or more processors. The one or more programs include instructions for performing the method of any of A1-A15.
(C1) In accordance with some embodiments, a non-transitory computer-readable storage medium stores one or more programs for execution by one or more processors. The one or more programs include instructions for performing the method of any of A1-A15.
As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for processing data, comprising:
at a computer system having one or more processors and memory:
establishing a plurality of data paths based on the one or more processors and the memory, the plurality of data paths being substantially parallel and including a first data path;
obtaining input data;
processing the input data in the plurality of data paths to generate a plurality of output data; and
for at least the first data path:
determining a first delay state of the first data path; and
based on the first delay state, dynamically allocating a first subset of the one or more processors for processing the input data in the first data path.

2. The method of claim 1, wherein dynamically allocating the first subset of the one or more processors for processing the input data in the first data path further comprises:
varying at least one of a size and a type of the first subset of the one or more processors.

3. The method of claim 1, wherein determining the first delay state of the first data path further comprises:
determining a first delay time of the first data path; and
determining whether the first delay time satisfies a first delay requirement, the first delay state indicating whether the first delay requirement is satisfied.

4. The method of claim 3, wherein dynamically allocating a first subset of the one or more processors further comprises:
in accordance with a determination that the first delay time does not satisfy the first delay requirement, implementing at least one of:
based on the first delay time, increasing a size of the first subset of processors; and
changing a type of the first subset of processors from a central processing unit (CPU) type to another type of processor.

5. The method of claim 3, wherein dynamically allocating a first subset of the one or more processors further comprises:
in accordance with a determination that the first delay time satisfies the first delay requirement, implementing at least one of:
based on the first delay time, decreasing a size of the first subset of processors allocated for processing the input data in the first data path; and
changing a processor type of the first subset of processors to a central processing unit (CPU) type.

6. The method of claim 3, wherein determining the first delay time of the first data path includes:
establishing a duplicate of the first data path in a test environment; and
measuring a delay time of the duplicate of the first data path in the test environment.

7. The method of claim 1, further comprising:
for at least the first data path, dynamically allocating a first cache memory space for processing the input data in the first data path.

8. The method of claim 1, wherein the plurality of output data includes first output data that are generated by the first data path and used to generate a first instruction, the method further comprising:
in response to the first instruction, controlling a machine to implement an operation on a target operation automatically and without human intervention.

9. The method of claim 8, wherein determining the first delay state of the first data path further comprises:
determining a wait time between generation of the first output data by the first data path and an initiation of generation of the first instruction;
comparing the wait time with a wait tolerance time, the first delay state indicating whether the wait time is longer than the wait tolerance time.

10. The method of claim 9, wherein dynamically allocating the first subset of the one or more processors further comprises:
in accordance with a determination that the wait time is longer than the wait tolerance time, implementing at least one of:
increasing a size of the first subset of processors allocated for processing the input data in the first data path; and
changing a processor type of the first subset of processors to a GPU type.

11. The method of claim 9, wherein dynamically allocating the first subset of the one or more processors further comprises:
in accordance with a determination that the wait time is equal to or less than the wait tolerance time, implementing at least one of:
decreasing a size of the first subset of processors allocated for processing the input data in the first data path; and
changing a processor type of the first subset of processors to a CPU type.

12. The method of claim 1, wherein processing the input data in the plurality of data paths to generate the plurality of output data further comprises:
applying one or more data processing models successively in the first data path to process the input data.

13. The method of claim 1, wherein the plurality of data paths further includes a second data path, the method further comprising:
for the second data path, determining a second delay state of the second data path, wherein the first subset of processors is dynamically allocated based on both the first delay state of the first data path and the second delay state of the second data path.

14. The method of claim 1, wherein the plurality of data paths further includes a set of one or more second data paths, and the first subset of processors is dynamically allocated for processing the input data in the first data path independently of a delay state of the set of one or more second data paths.

15. The method of claim 1, further comprising:
determining a first delay time of the first data path; and
in accordance with a determination that the first delay time of the first data path satisfies a first delay requirement, establishing a set of one or more second data paths each having the first delay time.

16. A computer system, comprising:
one or more processors; and
memory storing one or more programs for execution by the one or more processors, the one or more programs including instructions for:
establishing a plurality of data paths based on the one or more processors and the memory, the plurality of data paths being substantially parallel and including a first data path;
obtaining input data;
processing the input data in the plurality of data paths to generate a plurality of output data; and
for at least the first data path:
determining a first delay state of the first data path; and
based on the first delay state, dynamically allocating a first subset of the one or more processors for processing the input data in the first data path.

17. The computer system of claim 16, the one or more programs further including instructions for:
for at least the first data path, dynamically allocating a first cache memory space for processing the input data in the first data path.

18. The computer system of claim 16, wherein the instructions for dynamically allocating the first subset of the one or more processors for processing the input data in the first data path further include instructions for:
varying at least one of a size and a type of the first subset of the one or more processors.

19. The computer system of claim 16, wherein the instructions for determining the first delay state of the first data path further include instructions for:
determining a first delay time of the first data path; and
determining whether the first delay time satisfies a first delay requirement, the first delay state indicating whether the first delay requirement is satisfied.

20. A non-transitory computer-readable storage medium, storing one or more programs for execution by one or more processors, the one or more programs further comprising instructions for:
establishing a plurality of data paths based on the one or more processors and the memory, the plurality of data paths being substantially parallel and including a first data path;
obtaining input data;
processing the input data in the plurality of data paths to generate a plurality of output data; and
for at least the first data path:
determining a first delay state of the first data path; and
based on the first delay state, dynamically allocating a first subset of the one or more processors for processing the input data in the first data path.
